(19) United States
(12) Patent Application Publication
(10) Pub. No.: US 2001/0040396 A1
(43) Pub. Date: Nov. 15, 2001

(54) Head rest for a vehicle seat

(76) Inventors: Olaf Kreuels, Zweibrucken (DE); Thomas Jung, Aschbach (DE); Andreas Berberich, Landstuhl (DE); Volker Schafer, Otterbach (DE); Dieter Braun, Otterberg (DE); Peter Baumann, Kaiserslautern (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/776,509

(22) Filed: Feb. 2, 2001

(30) Foreign Application Priority Data
Feb. 3, 2000 (DE) 100 04 766.1

(51) Int. Cl. B60N 2/42

(52) U.S. Cl. 297/216.12

(57) ABSTRACT

In a head rest for a vehicle seat, in particular for an automobile seat, with a head rest bar, which mounts a head rest body, a part of the head rest body automatically moves forward relative to a remaining part of the head rest body in the event of a certain type of crash.

### BACKGROUND OF THE INVENTION

The invention relates to a head rest for a vehicle seat, in particular an automobile seat, with a head rest bar carrying a head rest body.

In a conventional head rest, the head rest is adjusted to a certain height and a certain inclination. In the event that the head rest is adjusted so that the spacing between the head of the seat user and the head rest is too large, the seat user may suffer a whiplash injury (cervical spine syndrome) in the instance of a crash.

### SUMMARY OF THE INVENTION

In accordance with one aspect of the present invention, a head rest with improved crash properties is provided. According to this aspect, the head rest includes a head rest bar and a head rest body, with the head rest body including a reference part mounted to the head rest bar and a movable part mounted and biased for moving forwardly away from the reference part. Also in accordance with this aspect, a holding mechanism is provided for restricting the forward movement of the movable part of the head rest body before a crash, and for allowing the forward movement of the movable part of the head rest body in response to the crash, so that the movable part of the head rest body moves forward relative to the reference part of the head rest body in response to the crash. In accordance with this aspect and in the event of a rear end crash, the movable part of the head rest body is forwardly accelerated together with the vehicle. That is, in the event of a crash, in particular a rear end crash, a portion of the head rest body is caused to move forward relative to the remaining head rest body, so that the upholstery of the head rest will come as close as possible to the head of the seat user. This will give the seat user better protection against injuries, in particular against the so-called cervical spine syndrome. This is especially important when the seat back as a whole is considerably inclined toward the back. The invention may be used for all kinds of vehicle seats, for example, for front seats or rear benches in automobiles, or for passenger seats in airplanes. The head rest may be designed and constructed in a corresponding manner likewise for the event of a head-on crash.

In a preferred embodiment, a mass integrated in the rear portion of the head rest remains in the event of a crash in its state of motion due to its inertia, thereby opening a locking mechanism of the crash-active head rest system. The mass may also be provided in a different location and be connected, via corresponding transmission elements, to the locking mechanism in the head rest. In the event of a crash, springs may move the front portion of the head rest. Preferably, after a crash, the locking mechanism can again be engaged, so that the head rest is able to return to its initial position.

In the event that a person falls or strikes against the head rest from the back, the locking mechanism will not release, but will remain in its engaged condition. This eliminates misuse. Dynamic stresses, for example, bumpiness of the roadway, are likewise unable to release the locking mechanism.

In a preferred embodiment, the head rest is adjustable in its inclination, and the inclination changes in the event of a crash. This enables the head rest body to adapt its inclination better to the position of the head. Preferably, the head rest body is held by force-locking engagement, which is applied by springs for moving the forward movable portion of the head rest body, and which decreases in the event of a crash.

Swing motions, for example, of the releasing mass and/or the forward movable portion of the head rest body have the advantage that it is not necessary to provide a special guideway for the movable components, so that manufacturing costs are reduced. This also applies to a reduction of the number of components, for example, when parts of the locking mechanism arranged on the mass are made preferably integral therewith. The mass may also be constructed separate from the locking mechanism.

The movable portion of the head rest body may also be designed and constructed, for example, such that it performs a purely translational movement, a superposition of a translational and a pivotal movement, or a superposition of two swing motions. In the latter instance, it is possible to generate, for example, via a four-bar linkage, an inclined movement, or again a translational movement by means of slideways. For such swing motions, levers will be of advantage, which permit covering relatively large distances.

The head rest of the present invention may be a part of an automatic head rest adaptation system, i.e., the height of the head rest is automatically preadjusted in a coarse manner via the length adjustment of the vehicle seat. In the rearmost position of the vehicle seat, the head rest assumes its highest location, and in the foremost position the head rest assumes its lowest location. The height of the head rest may be readjusted by a manual adjustment of height.

### BRIEF DESCRIPTION OF THE DRAWINGS

In the following, the invention is described in more detail with reference to four embodiments illustrated in the drawings, in which:

FIG. 1 is a perspective view of a first head rest according to the invention with a schematically outlined upholstery, the head rest being in a state of use;

FIG. 2 is a sectional view along line II-II of FIG. 1;

FIG. 3 is a sectional view corresponding to FIG. 2 in a situation, wherein a release lever pivots rearward as a result of a rear end crash;

FIG. 4 is a sectional view corresponding to FIG. 2 in a situation, wherein springs have moved a front plate forward, and the remaining head rest body is pivoted rearward;

FIG. 5 is a schematic sectional side view along line V-V of FIG. 6, showing a portion of a second embodiment in a state of use, wherein the position of an impact body in the event of a crash is shown in phantom lines;

FIG. 6 is a rear view of the portion of the second embodiment shown in FIG. 5;

FIG. 7 is a schematic, perspective view of a portion of a third embodiment in its state of use shown without an impact body;

FIG. 8 is a view as in FIG. 7 showing the impact body after the occurrence of a rear end crash;

FIG. 9 is a side view of the release lever of FIGS. 7 and 8 with a release mass and return spring outlined in phantom lines;

FIG. 10 is a top view of a fourth embodiment in a state of use with an upholstery only outlined in phantom lines;

FIG. 11 is a top view as in FIG. 10 after occurrence of a rear end crash;

FIG. 12 is a perspective view of a lever system contained in the fourth embodiment in a state of use, when viewed obliquely from the bottom;

FIG. 13 is a view as in FIG. 12 after occurrence of a rear end crash;

FIG. 14 is a perspective, partially sectioned view of the locking mechanism of the fourth embodiment; and

FIG. 15 is a partially sectioned side view of a mass sensor of the fourth embodiment.

### DETAILED DESCRIPTION OF THE INVENTIONS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In a first embodiment, a head rest 1 for a vehicle seat comprises a U-shaped head rest bar 3. The following directional references relate to the arrangement of the vehicle seat in an automobile and in the normal traveling direction thereof. The vertically downward directed end sections of the head rest bar 3 are inserted into receptacles of the vehicle seat. An upholstered head rest body 5 is arranged on the horizontally extending center section. The head rest body 5 comprises a front clamping shell 6 and a rear clamping shell 7, whose semicylindrically curved inside profiles correspond to head rest bar 3. Together, the two clamping shells 6 and 7 enclose the head rest bar 3.

The rear clamping shell 7 mounts a rear plate 11 via a Z-shaped, upwardly and forwardly angled support arm 9. The rear plate 11 has the shape of an isosceles triangle that stands on its apex. The front clamping shell 6 mounts a front plate 12, which has likewise the shape of an isosceles triangle standing on its apex. With its upper corners, the front plate 12 is arranged in congruence with the rear plate 11, while its lower apex lies lower relative to the rear plate 11. A straight-line holding arm 14 projects rearward from the front plate 12 approximately from its center of gravity, and extends through a corresponding guideway in rear plate 11 to the rear side thereof. The holding arm 14 extends perpendicular to a dividing plane of the two clamping shells 6 and 7.

Between the two upper corners and the lower apex of the front plate 12 on the one hand, and the two upper corners of the rear plate 11 and the support arm 9, respectively on the other hand, a spring 16 is provided. The three springs 16, which are designed and constructed as helical springs, are each arranged and mounted with their ends in round receptacles provided in the region of the aforesaid corners and apexes. In the state of use of head rest 1, the three springs 16 are totally compressed. Since the two upper springs 16 apply together a greater torque than the lower spring 16, the front plate 12, which is supported on holding arm 14 in lever fashion, is pushed with front clamping shell 6 arranged at its lower apex against rear clamping shell 7. The thereby developing clamping effect holds the head rest body 5 in its inclination relative to the head rest bar 3.

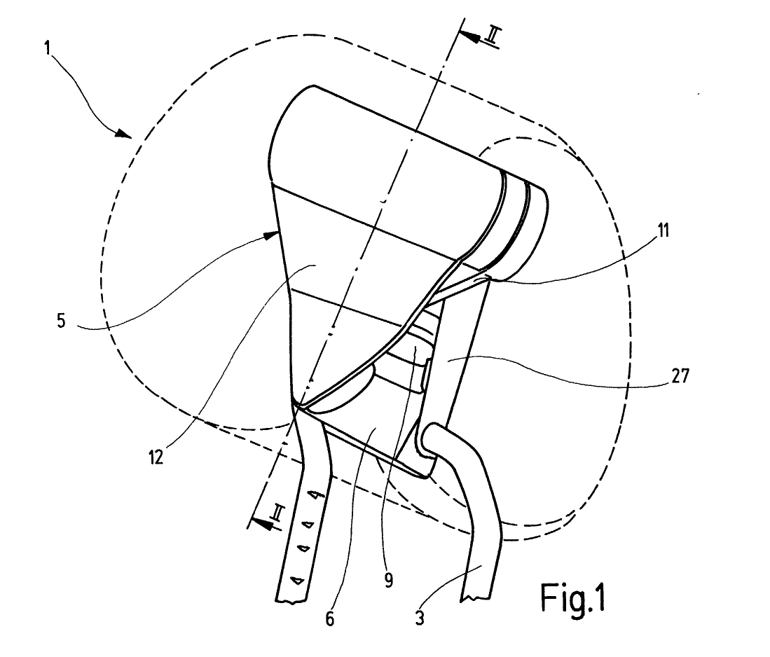

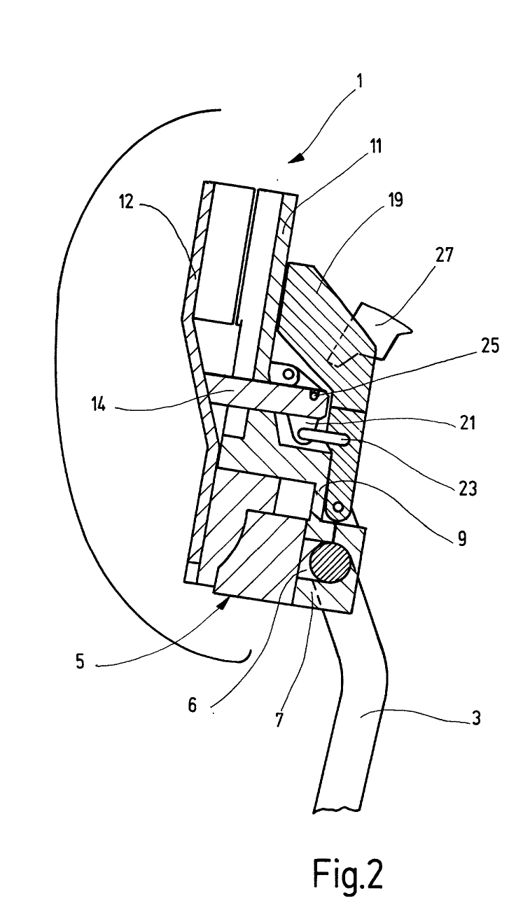

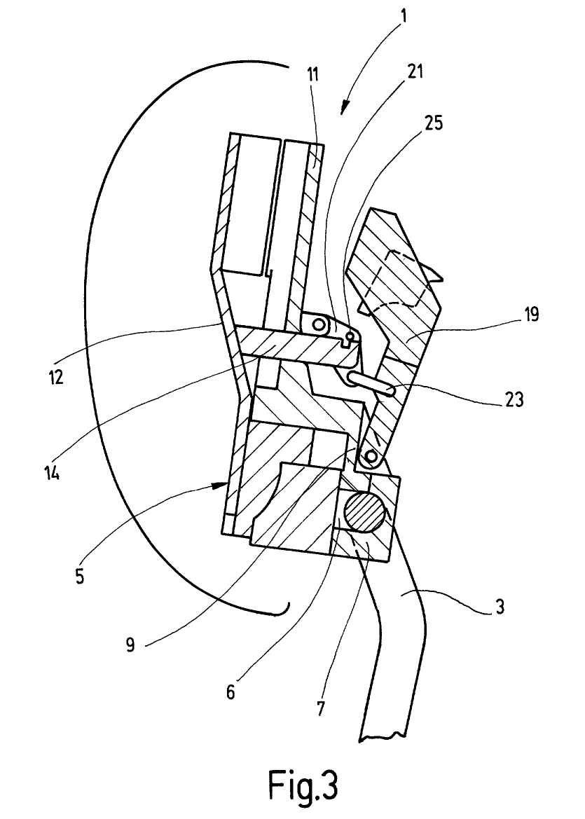

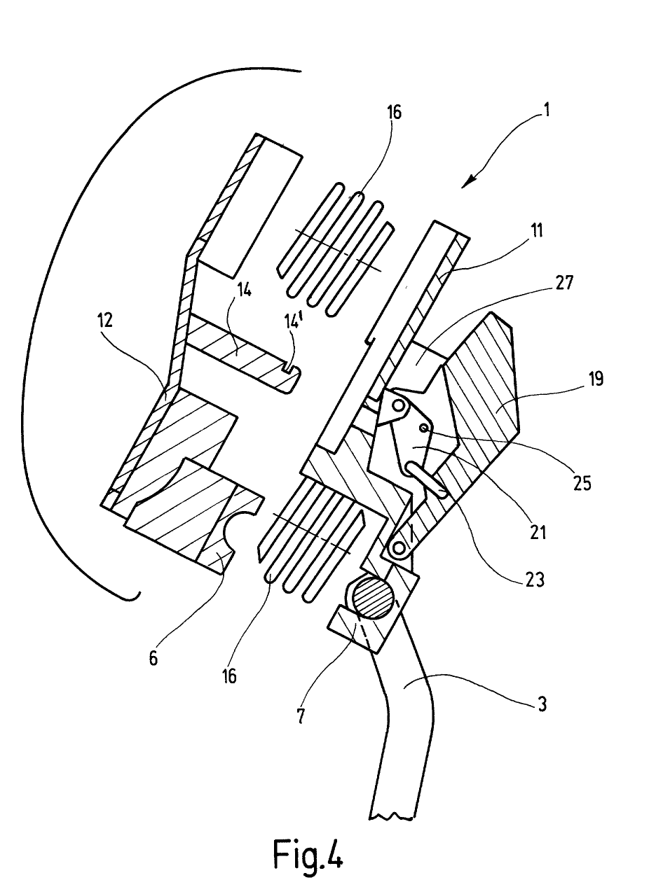

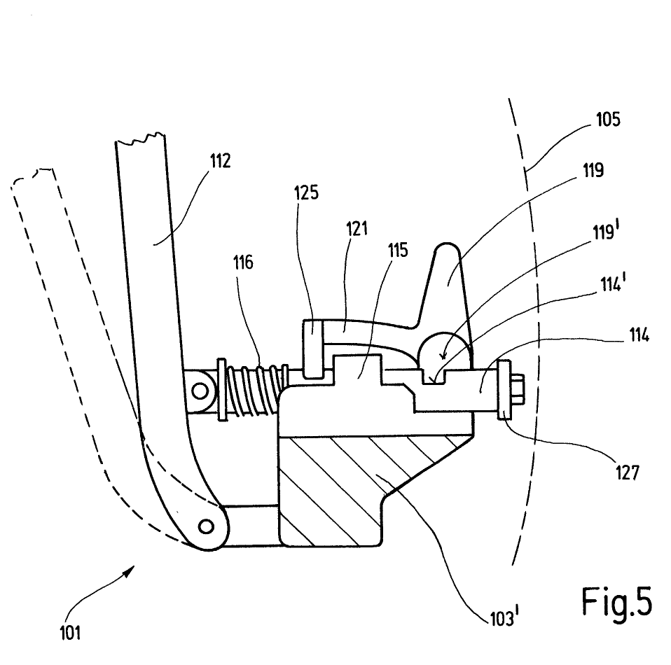

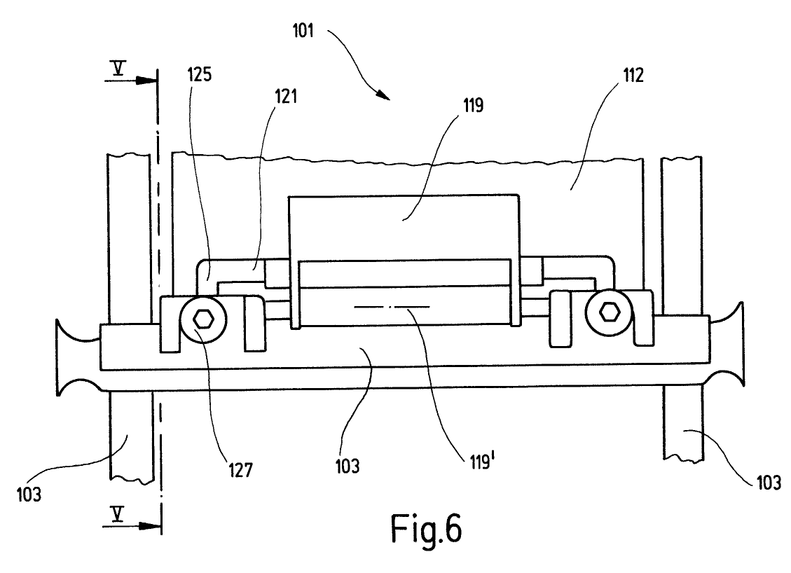

With its lower end, a club-shaped release lever 19 is pivotably mounted to the rearward directed back side of support arm 9, with an axis of rotation extending horizontally. With its free end, the release lever 19 extends upward. With the use of a corresponding material insert, the center of gravity of release lever 19 is located in the region of this free upper end. A triangular release plate 21 has an upper corner pivotably mounted to the rearward directed back side of rear plate 11. The axis of rotation of release plate 21 extends parallel to the axis of rotation of release lever 19. At its lower corner, the release plate 21 is connected via an entrainment member 23 to release lever 19, somewhat below the center thereof. From its rear corner, a release pin 25 projects horizontally from release plate 21. In the state of use of head rest 1, the release pin 25 lies in an upwardly open notch 14′ of holding arm 14, thereby securing the holding arm 14 in its position. As a result thereof, the front plate 12 is kept in contact with the rear plate 11. The entire head rest body 5 is covered by a padding and fabric, which are schematically illustrated by broken lines in FIG. 1.

In the event of a rear end crash, the structure of the vehicle is accelerated toward the front. This acceleration acts upon the center of gravity of release lever 19 with a time delay, since same remains in its state of motion due to the inertia of its mass. Consequently, when viewed in the reference system of head rest 1, this center of gravity is accelerated toward the back. As a result of its articulated connection to support arm 9, the release lever 19 starts to perform a swing motion. In so doing, the release lever 19 entrains entrainment member 23, which in turn moves release plate 21. The upward swinging release plate 21 removes release pin 25 from notch 14′, so as to release holding arm 14. The springs 16 push the front plate 12 together with front clamping shell 6 toward the front away from rear plate 11 and rear clamping shell 7, thereby eliminating the clamping effect. Due to the force of reaction of the springs 16 being supported on rear plate 11, and due to the force of inertia of rear plate 11, the now released rear plate 11 on support arm 9 swings rearward relative to the head rest bar 3. Two lateral, upwardly projecting stops 27 rigidly arranged on head rest bar 3 intercept the movement of the rear plate after about 20°.

As a result of the swing motion of rear plate 11 and the forward movement of front plate 12, which acts as an impact body, the upholstery of head rest 1 is moved closer to the head of the seat user for purposes of avoiding a whiplash injury (cervical spine syndrome). The front plate 12 may be designed and constructed such that it automatically locks in its extended position. Unless the head rest 1 is damaged as a result of the crash, it may be reversibly returned to its initial position. By compressing the springs 16, the front plate 12 and rear plate 11 are pushed together, until the release pin 25 comes to lie in notch 14′.

In the event of a head-on crash, the release lever 19 is pushed against the rear plate 11, so that the support arm 14 remains locked.

In a second embodiment, the directional references relate again to the arrangement of the vehicle seat in an automobile and its normal traveling direction (x-direction). A head rest 101 for a vehicle seat comprises two parallel head rest bars 103, which are inserted with their vertically downward directed end sections into receptacles of the vehicle seat, and which connect in the region of their upper end sections to a transverse bar 103′. An upholstered head rest body 105, which is arranged on transverse bar 103′ and constructed in mirror symmetry in the y-direction, comprises the components described in the following.

A plate-shaped impact body 112 of an approximately rectangular outline (impact element), is supported along one side on the transverse bar 103′ for rotation about an axis of rotation arranged somewhat below and in front thereof, when viewed in the x-direction. In a position of use, the impact body 112 is adjusted vertically upward and somewhat in front of transverse bar 103′. On the left and right, one pin-shaped holding arm 114 each is connected to the back side of impact body 112, aligned in the horizontal direction, and directed rearward opposite to the x-direction. Each holding arm 114 extends respectively in a largely groove-shaped, predominantly upwardly open guideway 115 on transverse bar 103′. Between a flange on holding arm 114 in the region of the pivotal point on impact body 112 and guideway 115, respectively one spring 116 is provided, which biases the impact body 112 toward the front in the state of use of head rest 101.

The transverse bar 103′ mounts parallel to it an elongate release mass 119, which is supported for rotation, and is rotatable about an axis of rotation 119′ parallel to transverse bar 103′. In the state of use of head rest 101, the release mass 119 extends above its axis of rotation 119′. One angled support arm 121 each laterally projects from the left and the right end of the release mass 119, extends first in the x-direction and then to the left (y-direction) and to the right respectively, and mounts on its end a downward (opposite to the z-direction) directed locking bar 125. In the state of use of head rest 101, each locking bar 125 lies in one (preferably the foremost) of several upwardly open notches 114′ of the corresponding holding arm 114, thereby securing the holding arm 114 associated to it in its position. At its end facing away from impact body 112, each holding arm 114 comprises, at a distance from the rear end of guideway 115, a flangelike stop 127, for example a washer, which is screwed to the holding arm 114 on its end face. The entire head rest body 105 is covered with a padding and fabric, which are not illustrated in the drawing.

In the event of a rear end crash, the structure of the automobile is accelerated toward the front. This acceleration acts upon the center of gravity of release mass 119 with a time delay, i.e., in the reference system of head rest 101, this center of gravity is rearwardly accelerated. Due to its rotatable support, the release mass 119 starts to perform a rearward directed swing motion about the axis of rotation 119′, thereby raising locking bars 125, via the two support arms 121, upward out of notches 114′, so that the holding arms 114 are released. The springs 116 acting as actuation springs relax and push the associated holding arms 114 forward together with the impact body 112 arranged thereon. The impact body 112 is caused to swing forward, until the stops 127 contact guideways 115. The locking bars 125 are then able to engage notches 114′ of holding arm 114, which are located further back.

As a result of the swing motion of impact body 112, the upholstery of head rest 101 is moved closer to the head of the seat user. Unless the head rest 101 is damaged by the crash, it will be possible to push impact body 112 again back, if need be, after disengaging locking bars 125, while compressing springs 116, until the holding arms 114 are again locked. In the event of a front-end crash, the release mass 119 pushes the locking bar 125 against notch 114′, so that the locking engagement does not release.

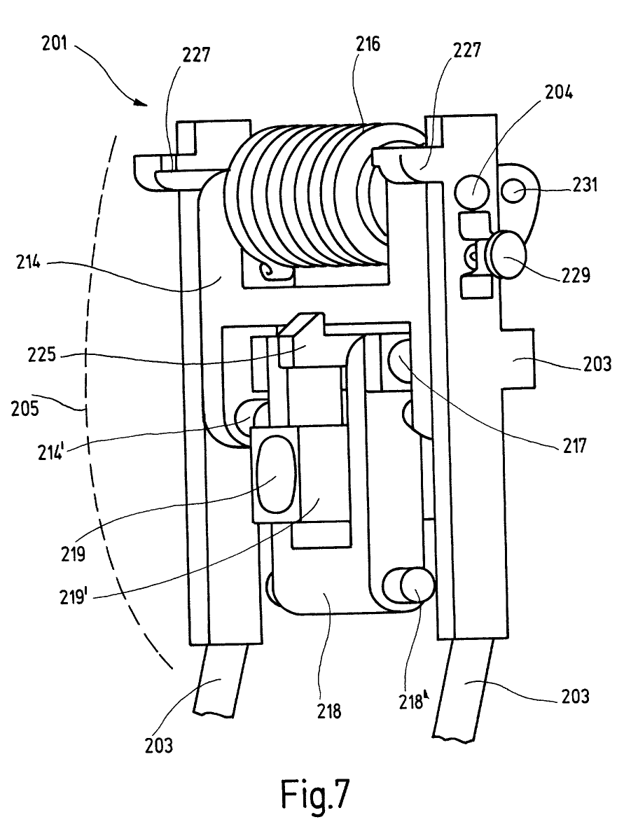

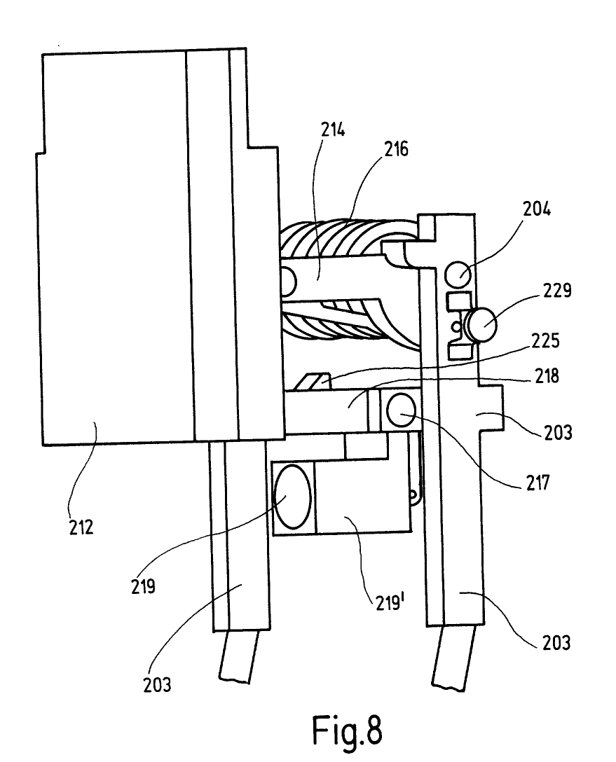

In a third embodiment, the directional references relate to the same reference system. A head rest 201 for a vehicle seat comprises two parallel head rest bars 203, which are inserted with their vertically downward directed end sections into receptacles of the vehicle seat, and which are connected in their upper end sections to a transverse bar 203′. Parallel to transverse bar 203′ and above same, an axle 204 extends between the two head rest bars 203, and is supported in same. An upholstered head rest body 205, which encloses transverse bar 203′, axle 204, and the following parts, is indicated by broken lines in FIG. 7.

A plate-shaped impact body 212 having an approximately rectangular outline with rounded edges is arranged in the front region of head rest body 205. The impact body 212 (impact element) is connected on its back side, approximately in the center thereof, to two ends of an H-shaped upper lever 214 by means of upper pins 214′. With its two other ends, the upper lever 214 is supported on axle 204. A torsion spring 216 biases the upper lever 214 forward (x-direction) and upward (z-direction). On its front side, the transverse bar 203′ comprises two bearing points 217 arranged parallel to the axle 204, which pivotally support a U-shaped lower lever 218 in the region of its end sections. To the center section thereof, impact body 212 is connected in its lower portion by means of pins 218′. The impact body 212, upper lever 214, head rest bars 203, and lower lever 218 form a four-bar linkage.

A cylindrically shaped release mass 219 is arranged for movement in the x-direction somewhat below the transverse bar 203′ in a guideway 219′ attached to transverse bar 203′. Connected to the back side of the release mass 219 is a transmission member 223, which extends through an opening in the back wall of guideway 219′, and is connected to an L-shaped locking lever 225 arranged somewhat above thereof. The locking lever 225 is supported for pivotal movement on a pin 225′ secured to the transverse bar parallel to the axle 204. At its forward directed end facing away from transmission member 223, the locking lever 225 comprises a hook, with which it holds, in the state of use of head rest 201, the upper lever 214 pivoted downward against the force of torsion spring 216. A return spring 223′ surrounding the transmission member 223 between the back wall of guideway 219′ and release mass 219, tensions the release mass 219 forward in the x-direction, until the locking lever 225 contacts guideway 219′.

In the event of a rear end crash, the structure of the automobile is accelerated toward the front. This acceleration acts upon the center of gravity of release mass 219 with a time delay, i.e., in the reference system of the head rest 201, this center of gravity is accelerated toward the back. Consequently, the release mass 219 moves against the force of return spring 223′ toward the back, and pushes via transmission member 223 against locking lever 225. The locking lever 225 pivots about pin 225′ downward and rearward, so that it releases the upper lever 214. This allows torsion spring 216 to pivot the upper lever 214 rapidly upward and forward, and likewise the lower lever 218 due to the construction as a four-bar linkage. The impact body 212 is thereby moved upward and forward respectively by about 70 mm, i.e., closer to the head of the seat user.

After 90°, the movement of the upper lever 214 is limited by two stops 227 arranged on head rest bars 203, so that the upper lever 214 extends forward perpendicular from head rest bars 203. To reduce injuries, this end position is secured after occurrence of the rear end crash by a detent 229, which is biased by a spring not shown, and which subsequently engages a blind-end retention bore 231 provided in the upper lever 214. The release mass 219 and locking lever 225 are moved by return spring 223′ to their initial position. Unless the actuated head rest 201 is damaged as a result of the crash, it will be possible to pivot the impact body 212 downward and rearward against the force of torsion spring 216, after pulling the spring-loaded detent 229 out of retention bore 231. Upon reaching the position of use, the locking lever 225 locks again the upper lever 214. A head-on crash will not cause a disengagement, since the locking lever 225 prevents a forward movement of release mass 219.

A corresponding reference system applies to a fourth embodiment. Within a head rest body 305, a head rest 301 comprises a rear plate 311, which is vertically arranged on head rest bars not shown, and a front plate 312 arranged in front thereof, which acts as an impact body (impact element), and is movable relative to the rear plate 311 by components described in the following. An upholstery arranged on plates 311 and 312 is not shown in greater detail for the sake of clarity.

A lever system consists of two shafts 332, which are arranged vertically (in z-direction) to the left and right of the center of rear plate 311, and supported in two bearings 335 each, which are mounted on the front side of rear plate 311, and consist of four bar-shaped levers 338, of which two each are secured with one end to one of shafts 332 at different heights, and which mount on their free end a transverse pin 340 each extending parallel to shaft 332. In the state of use of head rest 301, the levers 338 are pivoted toward one another in the way of folded hands. They are therefore all aligned in or opposite to the y-direction.

At their lower end, the shafts 332 comprise each a toothed segment 342 somewhat greater than a quadrant, whose center coincides with the respective shaft 332. The two toothed segments 342 mesh with each other. On the underside of the left toothed segment 342, a leg of a torsion spring 344 (leg spring) extends through a pin-shaped clamping point, and is kept movable for a length compensation. The torsion spring 344 is wound about a mandrel extending parallel to shaft 332 and associated to the nearest bearing 335 arranged above the left toothed segment 342. The torsion spring 344 extends up to this bearing 335, and is there secured with its other end to a stationary clamping point. The torsion spring 344 biases the left toothed segment 342 toward the front. In the state of use of head rest 301, a locking mechanism described in greater detail further below prevents the left toothed segment 342 from rotating. The right toothed segment 342 connects to the lowest lever 338 not only via the right shaft 332, but also by a connecting pin 346 arranged parallel thereto.

A handle 348 follows respectively on the left and the right side of front plate 312. The left and right handles 348 comprise on the side facing the front plate 312 four and three bars 350 respectively, which point each in the direction of the other handle 348, and which are provided with hooks at their ends. Two bars 350 of each handle 348 are connected to opposite bars 350 by a tension spring 352 or an elastic tape. All bars 350 extend in grooves, which are formed on the back side of front plate 312, and extend in the y-direction. These grooves accommodate one or two bars 350 as well as one transverse pin 340 at the same time. The grooves are designed and constructed as T-shaped slideways, so that corresponding material portions engage behind the transverse pins 340. The hooks on the ends of bars 350 lie against the transverse pin 340.

The locking mechanism comprises a pin casing 355, which is arranged above the left toothed segment 342 and connected to the rear plate 311, a pin 357, which is adapted for movement inside the pin casing 355 in the z-direction, and a first compression spring 359 (return spring), which pushes the pin 357 downward through an opening in the underside of the pin casing 355, so that in the locked state of use of the head rest 301, the pin engages a bore of the left toothed segment 342 below the pin casing 355. The upper end of pin 357 mounts the core of a Bowden cable 361, which supports itself with its sheath on pin casing 355.

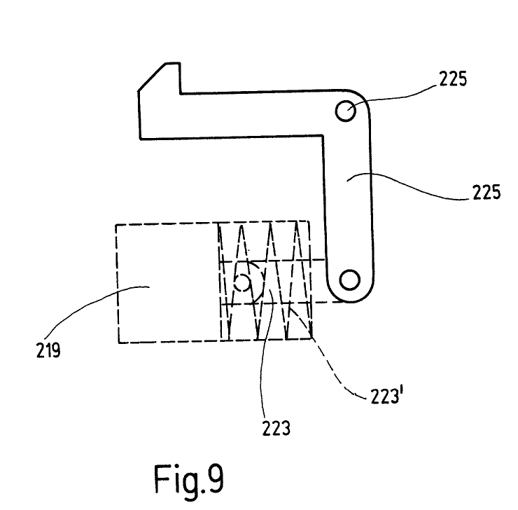

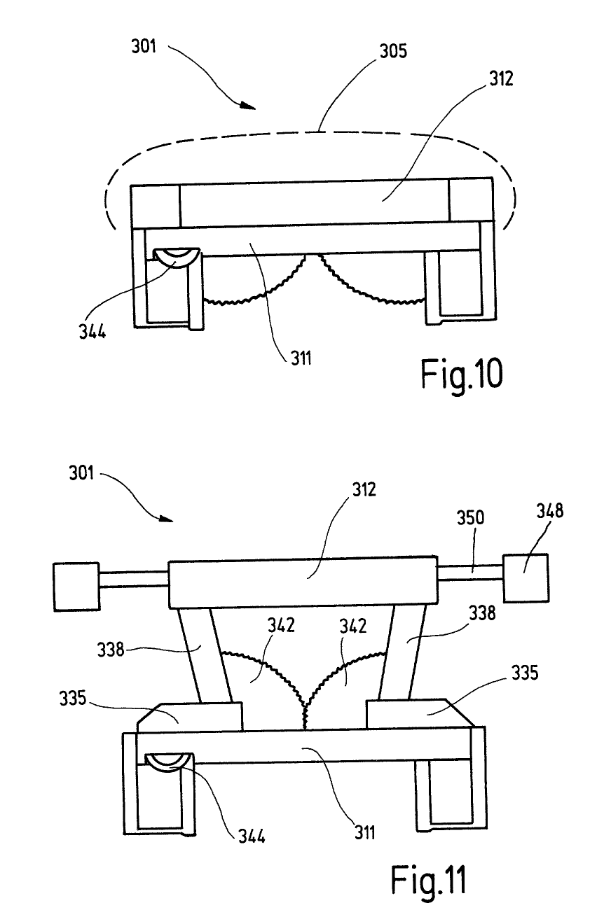

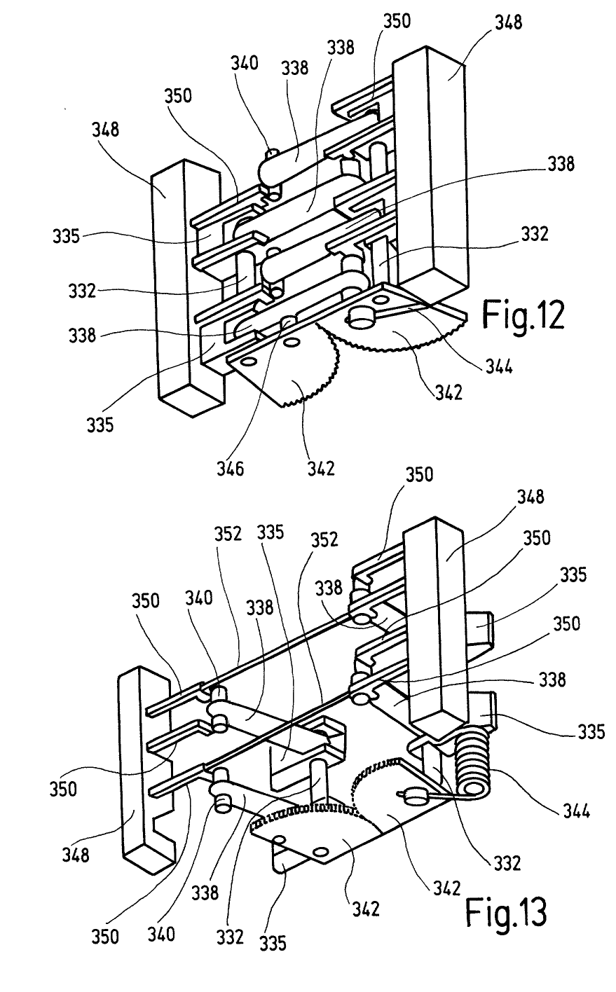

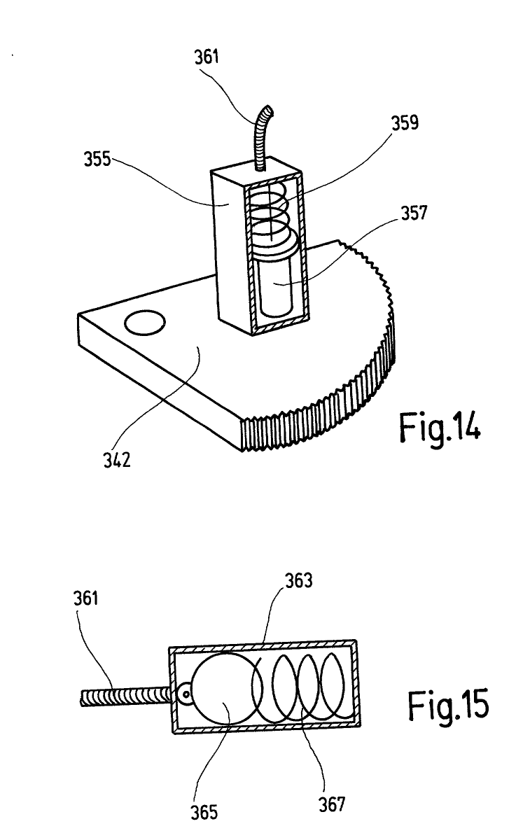

The Bowden cable 361 extends to a mass sensor arranged within the head rest 301, or elsewhere on the vehicle seat. The mass sensor comprises a sensor casing 363, which supports the sheath of the Bowden cable 361. The core of the Bowden cable 361 extends from the front into the sensor casing 363. There, it is attached to a spherical release mass 365. The release mass 365 is adapted for movement inside the sensor casing 363. A weak, second compression spring 367 (return spring) is provided in the rear region of the sensor casing 353 on the side of the release mass 365 facing away from the Bowden cable 361. The second compression spring 367 biases the release mass 365 slightly toward the front. In a modified version, the locking mechanism and the mass sensor may be designed and constructed in the same way as in the third embodiment, i.e. corresponding to FIG. 9.

In the event of a rear end crash, the release mass 365 stays behind, thereby pulling the Bowden cable 361, which in turn pulls the pin 357, so that the locking mechanism disengages. The torsion spring 344 untwists in the winding direction and, in so doing, pivots the left toothed segment 342 forward, which entrains the right toothed segment 342 via its serration. The two toothed segments 342 rotate the shafts 332, which in turn pivot the levers 338 toward the front. A stop formed on each bearing point 335 limits the swing motions to about 100°, so that the levers 338 move beyond their front dead center (at 90°). As a result of the swing motions of levers 338, the front plate 312 is pushed forward by about 70 mm, so that it comes with its upholstery closer to the head of the user. In this process, the transverse pins 340 move within the grooves of front plate 312 and push the handles 348 outward over the hooks of pins 350.

Unless the head rest 301 is damaged, it will be possible, after a crash, to push together the handles 348 with the assistance of tension springs 352, which push on transverse pins 340 via the bars 350. As a result, the levers 338 close and rotate shafts 332, which rotate toothed segments 342, so that the compression spring 344 is again tensioned. The two compression springs 359 and 367 see to it that the release mass 365 assumes its front position, and that pin 357 locks the left toothed segment 342. Thus, the initial position is again reached for the use of head rest 301.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed therein, they are used in a generic and descriptive sense only and not for purposes of limitation.

That which is claimed:

1. A head rest, for a vehicle seat, that automatically adjusts in a crash, comprising:
a head rest bar;
a head rest body having a reference part mounted to the head rest bar and a movable part mounted and biased for moving forwardly away from the reference part; and
a holding mechanism for restricting forward movement of the movable part away from the reference part before the crash, and for allowing forward movement of the movable part away from the reference part in response to the crash, so that the movable part moves forward relative to the reference part in response to the crash.

2. A head rest according to claim 1, wherein the holding mechanism includes a mass mounted for moving in response to the crash so that the inertia of the moving mass triggers the allowing of the forward movement of the movable part.

3. A head rest according to claim 2, wherein the mass is integrated into the head rest.

4. A head rest according to claim 2, wherein the movable part is mounted and biased for moving forwardly between rearward and forward positions, with the movable part being closer to the reference part in the rearward position than in the forward position, and wherein the holding mechanism further includes a locking mechanism mounted for releasably maintaining the movable part in the rearward position before the crash, and the mass is connected to the locking mechanism so that movement of the mass in response to the crash causes the locking mechanism to become automatically unlatched so that the movable part moves forward relative to the reference part.

5. A head rest according to claim 1, further comprising at least one spring, wherein the movable part is biased for moving forwardly away from the reference part by the spring.

6. A head rest according to claim 4, further comprising at least one spring, wherein the movable part is biased for moving forwardly away from the reference part by the spring, and the spring relaxes and causes the movable part to move forward relative to the reference part when the locking mechanism becomes automatically unlatched.

7. A head rest according to claim 6, wherein the head rest body is mounted to the head rest bar so that the head rest body can define an inclination with respect to the head rest bar, the inclination is adjustable, and the inclination changes in response to the crash.

8. A head rest according to claim 1, wherein the head rest body is mounted to the head rest bar so that the head rest body can define an inclination with respect to the head rest bar, the inclination is adjustable, and the inclination changes in response to the crash.

9. A head rest according to claim 8, further comprising a clamping mechanism mounting the head rest body to the head-rest bar, with the clamping mechanism being operative for providing a force-locking engagement for holding the head rest body in an inclination, and for decreasing the force-locking engagement in response to the crash so that the inclination of the head rest body changes automatically.

10. A head rest according to claim 5, further comprising clamping shells mounting the head rest body to the head rest bar so that the head rest body can define an inclination with respect to the head rest bar, wherein one of the clamping shells is mounted to the reference part, another of the clamping shells is mounted to the movable part, before the crash the spring creates a torque that results in the clamping shells being forced toward one another for providing a force-locking engagement to the head rest bar that can hold the head rest body in an inclination and allow for adjustment of the inclination, and the force-locking engagement decreases in response to the crash so that the inclination of the head rest body automatically changes.

11. A head rest according to claim 1, wherein at least one part of the head rest body swings rearward in the event of a rear end crash.

12. A head rest according to claim 1, wherein the movable part is mounted for pivoting relative to the reference part, and the movable part pivots relative to the reference part during the forward movement of the movable part.

13. A head rest according to claim 4, wherein the mass is mounted for pivoting in response to the crash, the locking mechanism includes at least one locking bar that is connected to the mass and performs a latching function for restricting the forward movement of the movable part before the crash, the locking bar pivots with the mass in response to the crash, and the pivoting of the locking bar causes the locking bar to unlatch to allow the forward movement of the movable part.

14. A head rest according to claim 1, further comprising at least one lever connected to the movable part and mounted for pivoting relative to the reference part, wherein the lever pivots relative to the reference part and carries the movable part forwardly during the forward movement of the movable part.

15. A head rest according to claim 14, wherein the lever is part of a movable four-bar linkage that connects the movable part to the reference part.

16. A head rest according to claim 14, wherein the lever is one of a plurality of levers mounted for pivoting relative to the reference part and carrying the movable part so that the movement of the movable part is translational.

17. A head rest according to claim 14, further comprising an element connected to the lever and moved laterally outward by the lever while the lever carries the movable part forwardly.

18. A head rest, for a vehicle seat, that automatically adjusts in a crash, comprising:
a head rest bar;
a head rest body having a reference part mounted to the head rest bar and a movable part mounted for moving forwardly away from the reference part;
at least one spring mounted for moving the movable part forwardly away from the reference part;
a lock element mounted for moving between a locked configuration, which is for restricting the spring from moving the movable part forwardly away from the reference part before the crash, and an unlocked configuration, in which the spring can move the movable part forwardly away from the reference part; and
a mass linked to the lock element and mounted for moving in response to the crash so that the inertia of the moving mass causes the lock element to move from the locked configuration to the unlocked configuration, so that the spring moves the movable part forward relative to the reference part in response to the crash.
